(19) United States
(12) Patent Application Publication
(10) Pub. No.: US 2003/0096687 A1
(43) Pub. Date: May 22, 2003

(54) Multiply tissue paper and a method of making it

(76) Inventors: Urban Widlund, Pixbo (SE); Anna Mansson, Molndal (SE)

Correspondence Address: YOUNG & THOMPSON, 745 SOUTH 23RD STREET 2ND FLOOR, ARLINGTON, VA, 22202

(21) Appl. No.: 10/300,742

(22) Filed: Nov. 21, 2002

Related U.S. Application Data
(60) Provisional application No. 60/331,778, filed on Nov. 21, 2001.

(51) Int. Cl. B31C 3/00

(52) U.S. Cl. 493/269

(57) ABSTRACT

A method of making a multi ply tissue paper web. The tissue web material is wound a plurality of revolutions in a helical manner to form a tube-like shape or alternatively the shape of a flattened tube, in which the edges of the web material of adjacent revolutions are partly overlapping, located substantially edge to edge or are located a small distance apart. The thus formed tube is then flattened to form a double- or multiply web. Alternatively web material is pulled out in the form of a helically twisted tube from the centre of a centre-fed roll of web material, and subsequently flattening the tube.

### FIELD OF THE INVENTION

The present invention refers to a multiply tissue paper and a method of making it. The tissue paper may be may be toilet paper, kitchen rolls, hand towels, wipes, napkins, facial tissue etc.

### BACKGROUND OF THE INVENTION

It is very common to laminate two or more tissue plies in order to produce a final multiply tissue product. Herewith a more flexible and softer tissue product is obtained as compared to if one single ply with a corresponding thickness and basis weight had been produced as for the laminated product. The absorbent capacity and the bulk are moreover improved. The lamination of two or more tissue plies is often made by means of gluing or embossing.

A tissue paper ply has different properties, especially different strength properties, in MD (machine direction) and CD (cross direction), so that the strength is considerably higher in MD than in CD. Bringing together two or more paper plies on top of each other will not change this difference, since the plies will have the same orientation.

Another problem in converting tissue paper and other paper into final products, such as rolled products, folded products etc. is that the width of the mother roll has to be adapted to the converting machine widths, or otherwise there will be a loss of material that cannot be used in the converting machines. This means a lack of flexibility in the production.

A further problem with multiply tissue products is that the plies easily separate from each other.

### SUMMARY OF THE INVENTION

The object of the present invention is to provide a method of making a multiply tissue paper which has more equivalent properties in MD and CD than conventional webs. It should further involve an increased flexibility in converting with regard to the width of the web used in the converting operation. These and further objects have according to the invention been solved by winding a tissue paper web a plurality of revolutions in a helical manner to form a tube-like shape or alternatively the shape of a flattened tube, in which the edges of the tissue web of adjacent revolutions are either fully overlapping/partly overlapping, located substantially edge to edge or located a small distance apart and in the case of a tube-like shape flattening the thus formed tube to form a multiply tissue paper web.

The term multiply web in this respect refers to a tissue or nonwoven material having two or more plies.

According to an alternative embodiment the tissue web is pulled out from the centre of a centre-fed roll of tissue paper web material, said web material being pulled out in the form of a helically twisted tube-like or flattened tube-like material, in which the edges of the web material of adjacent revolutions are either overlapping, located substantially edge to edge or the edges of adjacent revolutions are located a small distance apart and, in the case of a tube-like shape, flattening the thus formed tube to form a multiply tissue paper web.

According to one aspect of the invention at least two webs of tissue paper are wound to form said tube-shaped member or flattened tube. Said at least two webs of tissue paper may be different as to fibrous or chemical composition and/or physical properties.

The at least two webs of tissue paper are in one embodiment of the invention wound in counter directions.

The overlapping edges of the tissue paper web are preferably joined to each other by gluing, embossing or the like.

The invention further refers to a multi ply tissue paper web comprising a flattened tube of a helically wound web material in which adjacent edges of the wound web material are either partly overlapping, located substantially edge to edge or the edges of adjacent revolutions are located a small distance apart.

According to one embodiment the multi ply tissue comprises as least two helically wound tissue paper webs that are different as to fibrous or chemical composition and/or physical properties. At least two tissue paper webs may according to a further embodiment be are helically wound in counter directions.

### BRIEF DESCRIPTION OF THE DRAWINGS

The invention will below be described with reference to some embodiments shown in the accompanying drawings.

FIG. 1 is an illustration of a flat tissue paper web.

FIG. 2 shows the tissue paper web having been helically wound to form a tube-like shape.

FIG. 3 shows the tube of FIG. 2 in a flattened condition forming the final multiply tissue paper web.

FIG. 4 shows an alternative embodiment in which two tissue paper webs are helically wounded about a spindle in counter directions.

FIG. 5 illustrates a method of forming a multiply web material from a centre-fed roll of material.

### DESCRIPTION OF THE PREFERRED EMBODIMENTS

A tissue paper is defined as a soft absorbent paper having a basis weight below 65 g/m² and typically between 10 and 50 g/m². Its density is typically below 0.60 g/cm³, preferably below 0.30 g/cm³ and more preferably between 0.08 and 0.20 g/cm³. Moist tissue paper webs are usually dried against one or more heated rolls. A method which is commonly used for tissue paper is so called yankee drying. At yankee drying the moist paper web is pressed against a steam-heated yankee cylinder, which can have a very large diameter. The paper web is usually creped against the yankee cylinder.

Another drying method is so called through-air-drying (TAD). In this method the paper is dried by means of hot air blown through the moist paper web, often without a preceding wet pressing. In connection with the TAD drying the patterned structure of the drying fabric is transferred to the paper web. This structure is essentially maintained also in wet condition of the paper, since it has been imparted to the wet paper web.

In the international patent application no. PCT/SE98/02461 there is disclosed a method for producing an impulse dried paper, especially tissue paper, having a three-dimensional pattern, said paper having high bulk and softness. Impulse drying shortly involves that the moist paper web is passed through the press nip between a press roll or press shoe and a heated roll, which is heated to such a high temperature that a quick and strong steam generation occurs in the interface between the moist paper web and the heated roll. The three-dimensional embossment pattern is accomplished by means of a pattern provided on the heated roll. The counter means, for example a press felt, against which the paper is pressed in connection with the simultaneous impulse drying and shaping, has a non-rigid surface.

The present invention refers to all types of tissue paper. The tissue paper may be creped or non-creped. The creping may take place in wet or dry condition. It may further be foreshortened by any other methods, such as so called rush transfer between wires.

The fibers contained in the tissue paper are mainly pulp fibers from chemical pulp, mechanical pulp, thermo mechanical pulp, chemo mechanical pulp and/or chemo thermo mechanical pulp (CTMP). The fibers may also be recycled fibers. The tissue paper may also contain other types of fibers enhancing e.g. strength, absorption or softness of the paper. These fibers may be made from regenerated cellulose or synthetic material such as polyolefins, polyesters, polyamides etc.

The tissue paper coming out from the tissue machine as a single-ply paper sheet may be converted to the final tissue product in many ways, for example embossed, laminated to a multi-ply product, rolled or folded. A laminated multi-ply tissue product comprises at least two tissue plies, which are often joined by either adhesive or mechanically. The adhesive may be applied all over the paper or just in regions, for example dots or lines, or only along the edges of the product. The mechanical methods are mainly embossing either over the entire area of the plies or only along the edges, so called edge embossing. In the final product the plies as mostly easy detectable and may often be separated from each other as single plies.

The tissue paper coming out from the tissue paper machine may comprise one or more layers. In the case of more than one layer this is accomplished 1) in a multi-layered headbox, 2) by forming a new layer simultaneously or 3) by couching together already formed layers. These layers can not or only with considerable difficulty be separated from each other and are joined mainly by hydrogen bonds. The different layers may be identical or may have different properties regarding for example fibre composition and chemical composition.

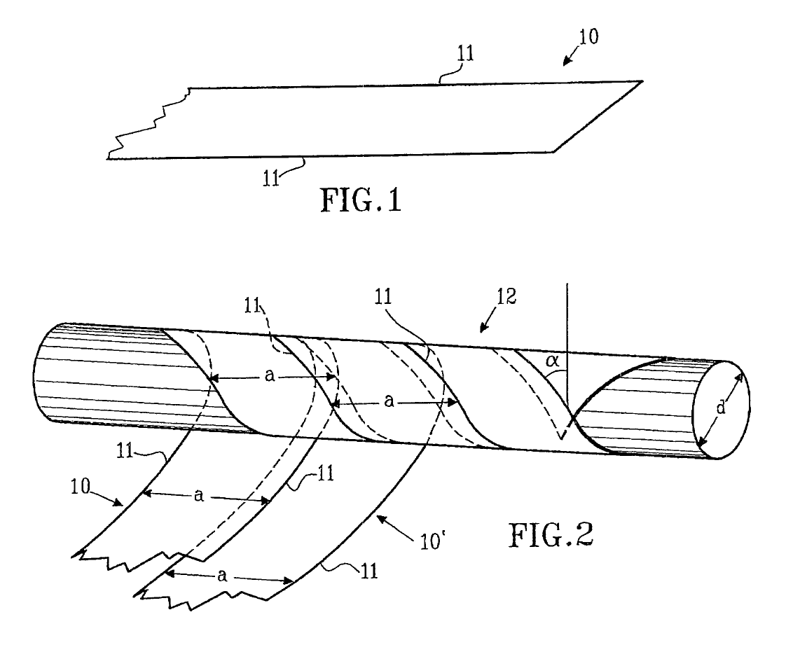

In FIG. 1 there is illustrated a flat tissue paper web 10 having a width a and longitudinal edges 11. The flat tissue paper web 10 is formed into a tube 12 by winding it a plurality of revolutions in a helical manner as is shown in FIG. 2. The edges 11 of the tissue paper web 10 of adjacent revolutions are partly overlapping or located substantially edge to edge. The overlap can be small, big or none at all. Alternatively the edges 11 of the tissue paper web 10 of adjacent revolutions are located a small distance apart. By varying the degree of overlap between the adjacent revolutions the number of plies in the multiply product that will be created, can be varied. The longitudinal edges 11 of the tissue paper web 10 may be coated with glue before winding the tissue paper web into the tube-shape, so that the overlapping edges will be glued to each other, or in the case of non-overlapping edges they will be glued to a surface of the web material. It would also be possible to join them to each other by mechanical embossing, or alternatively not join them at all.

The radius of the tube may be adjusted by adjusting the angle of climb α of the windings, so that the diameter d of the tube will decrease with an increasing angle α.

According to one embodiment of the invention two or more tissue paper webs 10 and 10′ are supplied to the winding station. This is illustrated with dashed lines in FIG. 2. The at least two webs 10 may completely or partly overlap each other or be located edge to edge or a small distance apart. The at least two webs 10 may be of the same or different kinds of tissue paper materials. In the case different tissue paper materials are used a multifunctional end product can be created. Said different tissue paper materials may be different with respect to fibrous or chemical composition and/or physical properties, such as basis weight, density, structure, embossing, apertured, non-apertured etc.

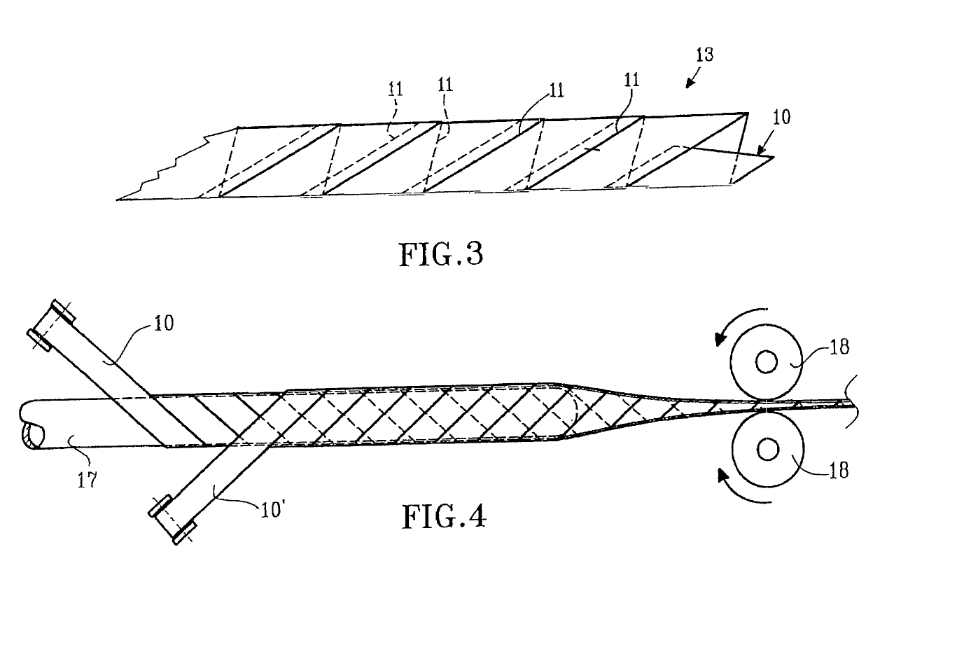

In a next step the tube 12 is flattened out to form a double-ply web 13 as shown in FIG. 3. The width of the double-ply web 13 thus formed will be Π·d/2. In case of no overlap or a very small overlap between the edges 11, the resulting web material 13 will be a substantially two-ply material. In the case of a big overlap the resulting web material 13 will at least in parts thereof comprise three and four plies.

According to an alternative embodiment the flat paper web 10 is helically wound around a flat member so that a “flattened tube” according to FIG. 3 is formed directly. This means that the step illustrated in FIG. 2 is omitted.

The resulting two- or multiply web 13 formed is then cut into the desired lengths and converted to final products such, for example rolls or folded products such as towels, napkins and the like. The web may also undergo treatments like embossing and the like.

According to a further embodiment, illustrated in FIG. 4 two tissue webs 10 and 10′ are wound around a spindle 17 in a helical manner and in counter directions. The two tissue webs may be the same or different as explained above. The edges of adjacent revolutions may overlap each other, be located edge to edge or a small distance apart as is disclosed above. The thus formed tube-shaped member is withdrawn form the spindle 17 and flattened between a pair of pressure rolls 18 to form a multiply web comprising at least four plies.

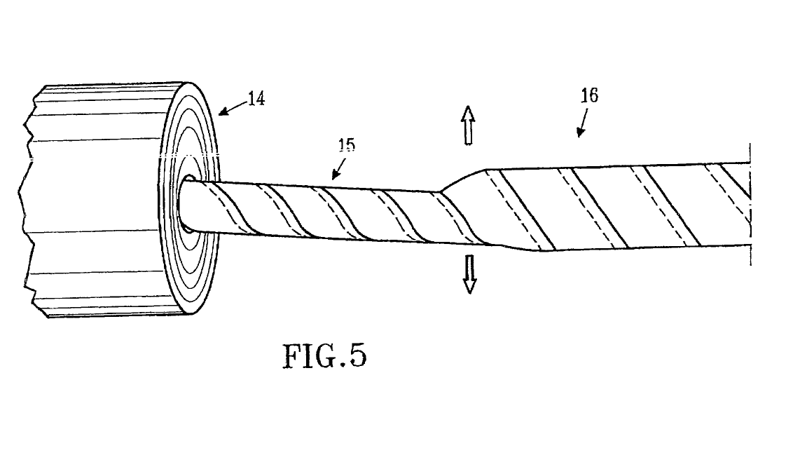

An alternative way of forming the multiply tissue paper web according to the invention is illustrated in FIG. 5. The numeral 14 denotes a centre-fed roll of web material from the centre hole of which the tissue paper web material is pulled out in the form of a tube-like string of web material consisting of a helically twisted tissue web material. The edges of the web material of adjacent revolutions are located a small distance apart. Herewith the diameter of the tube 15 may be adjustable by varying said speed of pulling out the web material. The tube 15 is at or shortly after the exit from the centre hole flattened to form a multiply tissue paper web 16. Alternatively the roll of web material is flattened itself, so that the web material will be pulled out from the centre hole in the form of a flattened tube member.

The invention provides the following advantages:

High flexibility in converting, since the mother roll, from which the initial flat paper web 10 is taken, can be split in arbitrary widths. Any such roll can be used to convert to products of any widths. The width of the produced two- or multiply web can be adjusted by adjusting the angle α as disclosed above.

No edge embossing is needed since the edges of the multiply products are perfectly sealed.

The number of plies in the multiply product created can be easily varied by varying the degree of overlap between the adjacent revolutions.

Because of this flexibility the loss of material is reduced, since the trim width can be minimized.

The width and length of the converted products can be chosen with great freedom.

In the produced two- or multiply tissue paper web 13 there will be a mixture of MD and CD-properties because of the helical configuration of the initial flat paper web 10.

There will further be no risk that the two plies in the web 13 will fall apart.

1. A method of making a multi ply tissue paper, which comprises:
winding at least one web of tissue paper a plurality of revolutions in a helical manner to form a tube-like shape or alternatively the shape of a flattened tube, in which the edges of the tissue paper web of adjacent revolutions are overlapping, located substantially edge to edge or the edges of adjacent revolutions are located a small distance apart; and
in the case of a tube-like shape, flattening the thus formed tube to form a double- or multiply tissue paper.

2. The method as claimed in claim 1, further comprising joining the overlapping edges of the web material to each other.

3. The method as claimed in claim 2, wherein the overlapping edges are joined to each other by gluing or embossing.

4. The method as claimed in claim 1, further comprising winding at least two webs of tissue paper to form said tube-shaped member or flattened tube.

5. The method as claimed in claim 4, wherein said at least two webs of tissue paper are different as to fibrous or chemical composition and physical properties.

6. The method as claimed in claim 4, wherein said at least two webs of tissue paper are wound in counter directions.

7. The method as claimed in claim 5, wherein said at least two webs of tissue paper are wound in counter directions.

8. A method of making a multi ply tissue paper, which comprises:
pulling out tissue paper from the centre of a centre-fed roll of tissue paper web, said tissue paper being pulled out in the form of a helically twisted tube-like or flattened tube-like material, in which the edges of the web material of adjacent revolutions are either partly overlapping, located substantially edge to edge or the edges of adjacent revolutions are located a small distance apart; and
in the case of a tube-like shape, flattening the thus formed tube to form a multiply tissue paper.

9. The method as claimed in claim 8, further comprising pulling out said tissue paper with a speed that is adjustable, so as to adjust the diameter of the helically twisted tube/flattened tube.

10. A multi ply tissue paper, which comprises a flattened tube of at least one helically wound tissue paper web in which adjacent edges of the wound web are overlapping, located substantially edge to edge or the edges of adjacent revolutions are located a small distance apart.

11. The multi ply tissue paper as claimed in claim 10, wherein the overlapping edges of the tissue web are joined to each other.

12. The multi ply tissue paper as claimed in claim 11, wherein the overlapping edges are glued or mechanically joined together.

13. The multi ply tissue paper as claimed in claim 10, which comprises at least two helically wound tissue paper webs that are different as to fibrous or chemical composition and physical properties.

14. The multi ply tissue paper as claimed in claim 11, which comprises at least two helically wound tissue paper webs that are different as to fibrous or chemical composition and physical properties.

15. The multi ply tissue paper as claimed in claim 10, which comprises at least two tissue paper webs helically wound in counter directions.

16. The multi ply tissue paper as claimed in claim 11, which comprises at least two tissue paper webs helically wound in counter directions.

17. The multi ply tissue paper as claimed in claim 12, which comprises at least two tissue paper webs helically wound in counter directions.

18. The multi ply tissue paper as claimed in claim 13, which comprises at least two tissue paper webs helically wound in counter directions.

19. The multi ply tissue paper as claimed in claim 10, wherein the longitudinal edges of the multi ply tissue are perfectly sealed.
